(19) United States
(12) Patent Application Publication
(10) Pub. No.: US 2012/0081019 A1
(43) Pub. Date: Apr. 5, 2012

(54) Fluorescent lamp circuit capable of being repaired and repeatedly used

(75) Inventor: Jim-Hung Liang, Taipei (TW)

(73) Assignee: SKYNET ELECTRONIC CO., LTD., Taipei (TW)

(21) Appl. No.: 12/926,509

(22) Filed: Nov. 23, 2010

(30) Foreign Application Priority Data
Sep. 30, 2010 (TW) 099133229

(51) Int. Cl. H05B 41/36

(52) U.S. Cl. 315/209 R

(57) ABSTRACT

The present invention is to provide a fluorescent lamp circuit capable of being easily repaired and repeatedly used even when one of filaments in a fluorescent light tube breaks because of age or defects, which will cause an electric arc between disconnected portions of the broken filament and generate a high resonant voltage and current in the resonant circuit. As soon as the resonant current flowing through a resonant capacitor exceeds an allowable current value of a circuit breaking element, the resonant current causes the circuit breaking element to form an open circuit, thereby promptly stopping the operation of the resonant circuit to prevent all the circuits and components in the fluorescent lamp circuit (except for the circuit breaking element) and plastic components that support the fluorescent light tube from burning which may otherwise result from an undue power demand of the resonant circuit and high heat generated by the electric arc.

### FIELD OF THE INVENTION

The present invention relates to a fluorescent lamp circuit, more particularly to a fluorescent lamp circuit capable of being easily repaired and repeatedly used even when one of filaments in a fluorescent light tube breaks because of age or defects, which causes an electric arc between the disconnected portions of the broken filament and generates a high resonant voltage and current in the resonant circuit due to an abrupt oscillation. As soon as the resonant current flowing through a resonant capacitor exceeds an allowable current value of a circuit breaking element, the resonant current causes the circuit breaking element to form an open circuit, thereby breaking the resonant circuit and stopping its operation to not only prevent all the circuits and components in the fluorescent lamp circuit, except for the circuit breaking element, from burning which may otherwise result from an undue power demand of the resonant circuit, but also prevent plastic components that support the fluorescent light tube from ignition which is otherwise attributable to the sustained high heat generated by the electric arc at the broken filament. In consequence, the fluorescent lamp circuit can be easily repaired and, after replacement of the fluorescent light tube and the circuit breaking element, be used again, thereby achieving resource conservation as well as environmental protection.

### BACKGROUND OF THE INVENTION

Magnetic ballasts—the most typical ballast circuits for fluorescent light tubes since the invention of fluorescent lighting—operate at the AC mains frequency in order to light fluorescent light tubes. Generally speaking, a ballast circuit lights up a fluorescent light tube by the following steps:

1. preheating the filaments at both ends of the fluorescent light tube;
2. generating a high voltage to ionize the argon in the light tube; and
3. stabilizing or limiting the lamp current in the light tube once the light tube is lit.

However, with the advent of the electronic era, it has been found that the lighting efficiency of a fluorescent light tube can be effectively increased by lighting the light tube at a frequency of a few tens kHz. Therefore, in recent years, various electronic ballast circuits have been developed for fluorescent lamps and widely used in fluorescent lighting fixtures, gaining favor over the magnetic ballast circuits, which are composed mainly of silicon steel plates and have such disadvantages as bulkiness, heavy weight, and a short starter service life.

Nowadays, with the advances in material science and manufacturing technology, the results of research and development of fluorescent light tubes have shown that the thinner the light tubes are, the higher the lighting efficiency will be. Hence, fluorescent light tubes with small tube diameters not only are popular among users, but also are designed in different shapes, including the various U shapes and spiral shapes commonly seen in commercially available energy-saving light bulbs. Featuring high luminous efficacy, small-diameter fluorescent light tubes have been the mainstream lighting devices for daily use and gradually replaced the tungsten filament-based incandescent light bulbs. Nevertheless, when a small-diameter fluorescent light tube is just lit or during its lighting process, the lamp bases at both ends of the light tube may generate heat suddenly and become fiery red. The high heat resulting from this abnormal phenomenon may even ignite the plastic components of the lamp bases. In view of this, international safety codes have been amended to include regulations and requirements of “end-of-life protection” for the electronic ballast circuits of T5 (16 mm) and smaller-diameter fluorescent light tubes.

While many electronic ballast circuits designed for fluorescent light tubes have passed the tests required in the aforesaid “end-of-life protection” regulations, these electronic ballast circuits are protective only upon occurrence of a significant difference in electrical resistance between the filaments at the two ends of a fluorescent light tube. In particular, these electronic ballast circuits cannot respond immediately to and hence fail to provide protection against the electric arc and high temperature instantly generated when a filament breaks as a result of aging or defects. Therefore, even though the electronic ballast circuits on the market may have passed the aforementioned “end-of-life protection” tests, the risks of igniting the plastic components of the lamp bases due to the electric arc and high temperature caused by a broken filament still exist.

Take commercially available electronic ballast circuits for example. FIGS. 1 to 3 illustrate three common electronic ballast circuits that share a similar half-bridge series-connected LC resonant circuit, with a few variations in design that are attributed to the different ways to preheat the filaments 32 at both ends of the fluorescent light tube 31. However, regardless of the variations in circuit design, the two ends of the resonant capacitor Cᵣ₃ in a commercially available electronic ballast circuit are always connected in parallel to the filaments 32 at both ends of the fluorescent light tube 31. Therefore, if any of the filaments 32 at the two ends of the fluorescent light tube 31 breaks, either because of age or defects, and thus gives rise to an electric arc that interrupts the lamp current in the fluorescent light tube 31, an abrupt oscillation, and consequently an extremely high resonant current, is bound to occur at the resonant capacitor Cᵣ₃, which together with the resonant inductor Lᵣ₃ forms a resonant circuit in the electronic ballast circuit. As a result, the resonant capacitor Cᵣ₃ may explode or damage other circuits and components in the electronic ballast circuit; even worse, the circuit board may be burned. Should the electric arc at the broken filament 32 exist for a relatively long time, the temperature of the lamp bases at both ends of the fluorescent light tube 31 will rocket to several thousand degrees, thus igniting the plastic components of the lamp bases at both ends of the fluorescent light tube 31, if not leading to more serious fire accidents. Presently, the industry is still in need of solutions to the aforesaid problem, and consumers have no other ways to deal with broken or burned fluorescent light tubes or electronic ballast circuits than to discard them. And yet while doing so, consumers are polluting the environment and contributing to a waste of resources without knowing it.

Recently, as the awareness of environmental protection rises, it has been a global campaign, governmental and industrial alike, to recycle, repair, and repeatedly use all sorts of articles. Nevertheless, when an electronic ballast circuit or a fluorescent light tube is no more good for use, either the filaments in the fluorescent light tube are broken beyond repair, or the circuits and components in the electronic ballast circuit are damaged by the aforementioned excessive resonant current. In other words, a damaged electronic ballast circuit or fluorescent light tube is not recyclable and reusable at all and hence becomes an obstacle to the foregoing environmental protection campaign. The issue to be addressed by the present invention is to design a structurally simple fluorescent lamp circuit (i.e., the electronic ballast circuit of a fluorescent lamp) capable of breaking the resonant circuit therein as soon as any filament of the fluorescent light tube breaks due to age or defects and causes an electric arc. Once the operation of the resonant circuit is stopped, the related circuits and components in the fluorescent lamp circuit are prevented from burning which may otherwise result from a sudden oscillation that generates an excessive resonant voltage and current at the resonant capacitor in response to an undue power demand of the resonant circuit. Thus, recyclability and reusability of the fluorescent lamp circuit are assured.

### BRIEF SUMMARY OF THE INVENTION

It is an object of the present invention to provide a fluorescent lamp circuit whose recyclability and reusability are assured. The fluorescent lamp circuit includes a self-excited or externally excited power driving circuit, a resonant circuit, and a circuit breaking element (e.g., a fuse). The power driving circuit is connected in parallel to the filaments at both ends of a fluorescent light tube. The resonant circuit includes a resonant inductor and a resonant capacitor. The resonant inductor is connected in series between the power driving circuit and one filament of the light tube. The resonant capacitor is connected in series to the circuit breaking element, and then the series-connected resonant capacitor and circuit breaking element are parallel-connected to the filaments at both ends of the fluorescent light tube. The circuit breaking element has an allowable current value that ensures all the components in the fluorescent lamp circuit other than the circuit breaking element are protected from burning. Should any one of the filaments in the light tube break because of age or defects, thus causing an electric arc between the disconnected portions of the broken filament and interrupting the lamp current of the fluorescent light tube, an abrupt oscillation will take place in the resonant circuit and result in a high resonant voltage and current. As soon as the resonant current flowing through the resonant capacitor exceeds the allowable current value of the circuit breaking element, the resonant current causes the circuit breaking element to form an open circuit, thereby breaking the resonant circuit and stopping its operation. If the circuit breaking element for ending the increasing resonant voltage and current is not provided, most of the circuits and components in the fluorescent lamp circuit will eventually be burned due to the excessive power demand of the resonant circuit. The present invention not only prevents all the circuits and components in the fluorescent lamp circuit, except for the circuit breaking element, from burning which may otherwise result from an undue power demand of the resonant circuit, but also prevents the plastic components that support the lamp bases of the fluorescent light tube from ignition which is otherwise attributable to the sustained high heat generated by the electric arc at the broken filament. In consequence, the risks of fire accidents are effectively eliminated, and the fluorescent lamp circuit can be easily repaired and, after replacement of the fluorescent light tube and the circuit breaking element, be used again, thereby achieving resource conservation as well as environmental protection.

### BRIEF DESCRIPTION OF THE SEVERAL VIEWS OF THE DRAWINGS

The technical means and circuit operation of the present invention can be best understood by referring to the following detailed description of the preferred embodiments in conjunction with the accompanying drawings, in which:

FIG. 1 is a circuit diagram of a conventional electronic ballast which starts a fluorescent light tube by preheating the filaments with a positive temperature coefficient (PTC) resistor;

FIG. 2 is a circuit diagram of a typical series-connected resonant electronic ballast;

FIG. 3 is a circuit diagram of a conventional electronic ballast which starts a fluorescent light tube by preheating the filaments with resistors;

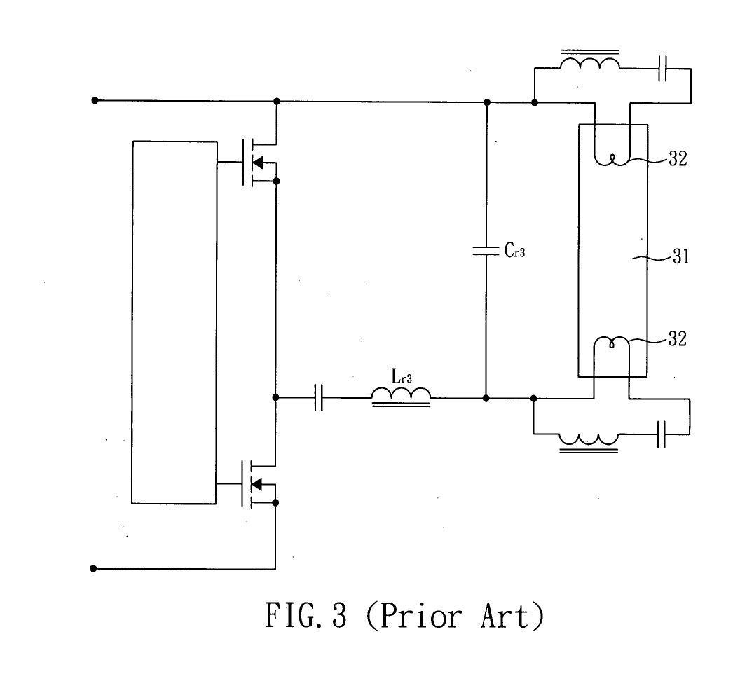

FIG. 4 is a circuit diagram of a fluorescent lamp circuit according to a first embodiment of the present invention; and

FIG. 5 is a circuit diagram of a fluorescent lamp circuit according to a second embodiment of the present invention.

### DETAILED DESCRIPTION OF THE INVENTION

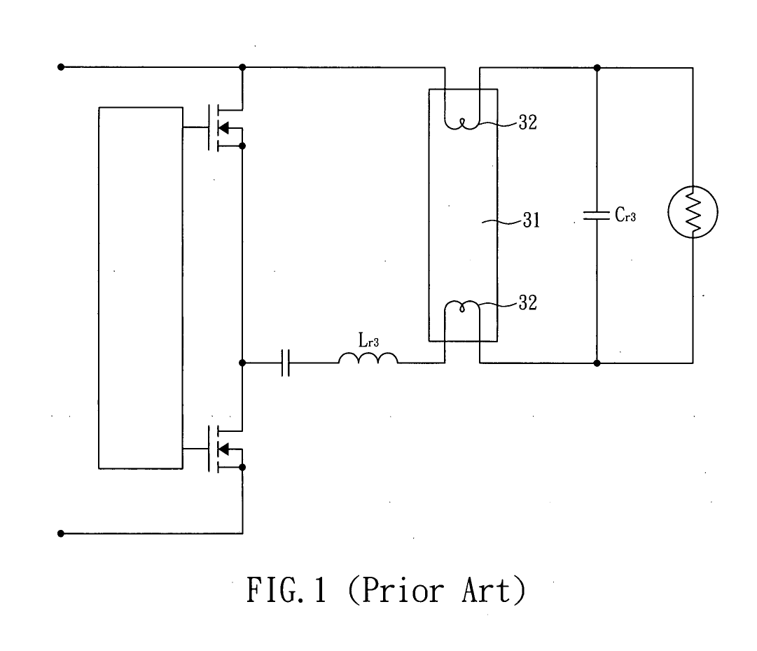

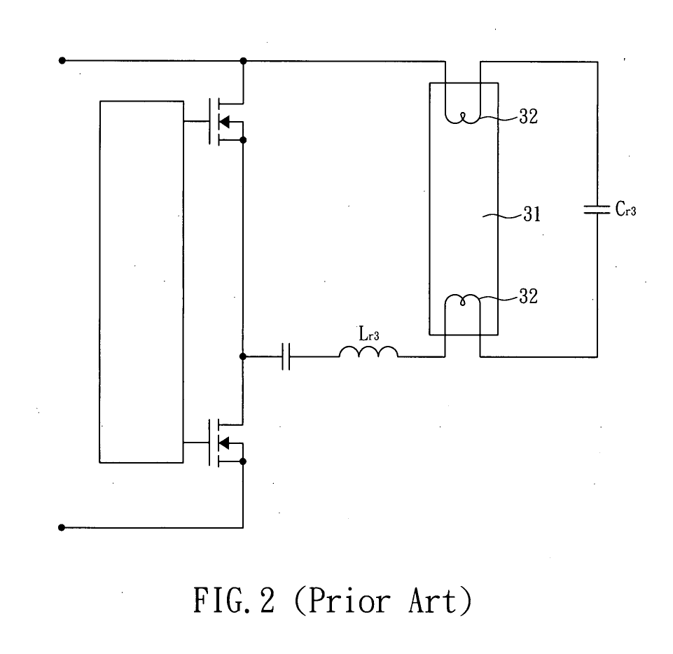

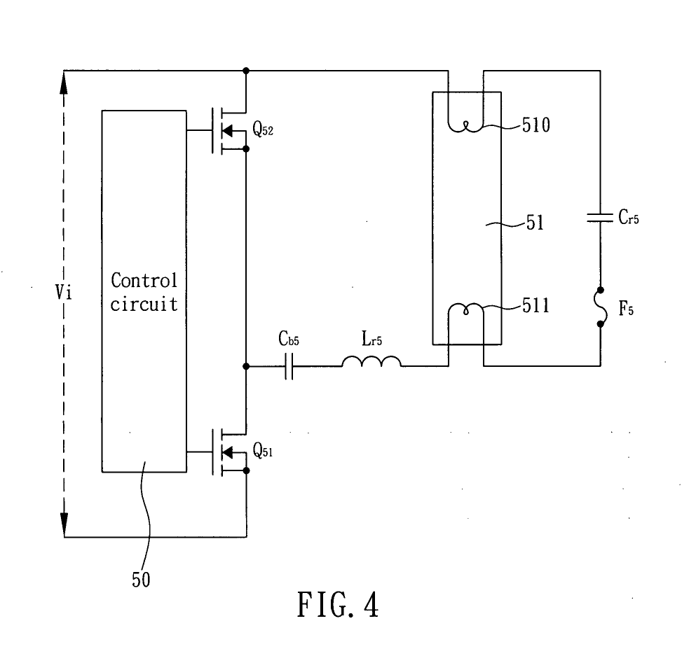

The present invention provides a fluorescent lamp circuit assured of recyclability and reusability. Please refer to FIG. 4 for a first embodiment of the present invention, which is essentially an improvement over the typical series-connected resonant electronic ballast illustrated in FIG. 2. As shown in FIG. 1, a fluorescent lamp circuit includes a power driving circuit, wherein the power driving circuit at least includes a control circuit 50 and two power switches Q₅₁ and Q₅₂. If the power driving circuit is externally excited, the control circuit 50 can be a control chip or a resonant control chip. If the power driving circuit is self-excited, the control circuit 50 can be a self-excited oscillator circuit composed of a small transformer. The control circuit 50 is configured to switch the first power switch Q₅₁ and the second power switch Q₅₂ respectively. The gates of the first power switch Q₅₁ and of the second power switch Q₅₂ are connected to the corresponding control pins of the control circuit 50 respectively. The drain of the second power switch Q₅₂ is connected to the positive electrode of a power source Vi, the source of the second power switch Q₅₂ is connected to the drain of the first power switch Q₅₁, and the source of the first power switch Q₅₁ is connected to the negative electrode of the power source Vi. Thus, with the control circuit 50 switching the first power switch Q₅₁ and the second power switch Q₅₂, the fluorescent lamp circuit receives a stable input voltage from the power source Vi and uses the input voltage to light a light tube 51. The two ends of the light tube 51 are provided with a first filament 510 and a second filament 511 respectively. The first filament 510 has one end connected to the drain of the second power switch Q₅₂ while the second filament 511 has one end connected to the source of the second power switch Q₅₂ by way of a resonant inductor Lᵣ₅ and a blocking capacitor C_{b5} arranged in that order. In addition, a circuit breaking element F₅ and a resonant capacitor Cᵣ₅ are series-connected between the other end of the first filament 510 and the other end of the second filament 511. Thus, the fluorescent lamp circuit of the present invention is formed.

With reference to FIG. 4, the circuit breaking element F₅, which can be a fuse or other equivalent elements, has an allowable current value that ensures all the circuits and components in the fluorescent lamp circuit other than the circuit breaking element F₅ are prevented from burning. The control circuit 50 switches the first power switch Q₅₁ and the second power switch Q₅₂ in such a way that an oscillation, and consequently an increasing resonant voltage, takes place at the resonant capacitor Cᵣ₅, which together with the resonant inductor Lᵣ₅ forms a resonant circuit. Once the resonant voltage is high enough to ionize the argon in the light tube 51, the light tube 51 begins to be lit up. While the light tube 51 is being lit, the liquid mercury in the light tube 51 is excited and becomes mercury vapor. The atoms of the mercury vapor, when hit by the accelerated electron flow in the light tube 51, start to transition between electronic energy levels and thereby emit an ultraviolet light. As the ultraviolet light strikes the phosphor powder on the inner wall of the light tube 51, the phosphor powder converts the ultraviolet light into visible light. During the light tube lighting process described above, a lamp current in the light tube 51 flows through the two filaments 510 and 511; consequently, the filaments 510 and 511 generate not only heat but also hot electrons that keep supplying the lamp current. As the two filaments 510 and 511 are tungsten filaments coated with electronic powder (typically barium oxide), the electronic powder is gradually depleted while the filaments 510 and 511 generate heat and hot electrons. Because of that, the filament 510 or 511 will get thinner and thinner and eventually break due to excessive impedance. In some instances, however, the filament 510 or 511 may break because of defects in themselves. In either case, when the filament 510 or 511 breaks, the remaining portions of the broken filament tend to be so close to each other that an electric arc is bound to occur at the broken filament and keep generating very high heat. Should that happen, the lamp current in the light tube 51 will be interrupted, causing a rapid oscillation in the resonant circuit; as a result, a high resonant voltage and resonant current are generated. When the resonant current running through the resonant capacitor Cᵣ₅ is higher than the allowable current value of the circuit breaking element F₅, the resonant current turns the circuit breaking circuit F₅ into an open circuit at once, so the resonant circuit is broken and stops working. If the fluorescent lamp circuit lacks the circuit breaking element F₅ series-connected to the resonant capacitor Cᵣ₅, the resonant voltage and resonant current generated by the rapid oscillation in the resonant circuit when the filament 510 or 511 breaks will increase incessantly and sooner or later burn the circuits and components in the fluorescent lamp circuit, including the power switches Q₅₁ and Q₅₂. Moreover, the continuous high temperature, sometimes up to several thousand degrees, generated by the electric arc at the broken filament may even burn or ignite the plastic components of the lamp bases of the light tube 51. With the circuit breaking element F₅ in place, the fluorescent lamp circuit of the present invention can protect the plastic components supporting the lamp bases of the fluorescent light tube from ignition by sustained high heat generated from the electric arc at a broken filament; therefore, fire accidents attributable to broken filaments are effectively prevented. In addition, the present invention also ensures that, except for the circuit breaking element F₅, all the other circuits and components in the fluorescent lamp circuit (e.g., the control circuit 50, the first power switch Q₅₁, the second power switch Q₅₂, the resonant inductor Lᵣ₅, the blocking capacitor C_{b5}, and the resonant capacitor Cᵣ₅) will remain in good condition and hence recyclable and reusable when the light tube 51 is out of order. Once repaired, the fluorescent lamp circuit only requires the light tube 51 and the circuit breaking element F₅ be replaced so that the fluorescent lamp circuit is good for use again. By doing so, resource conservation and environmental protection are simultaneously attained.

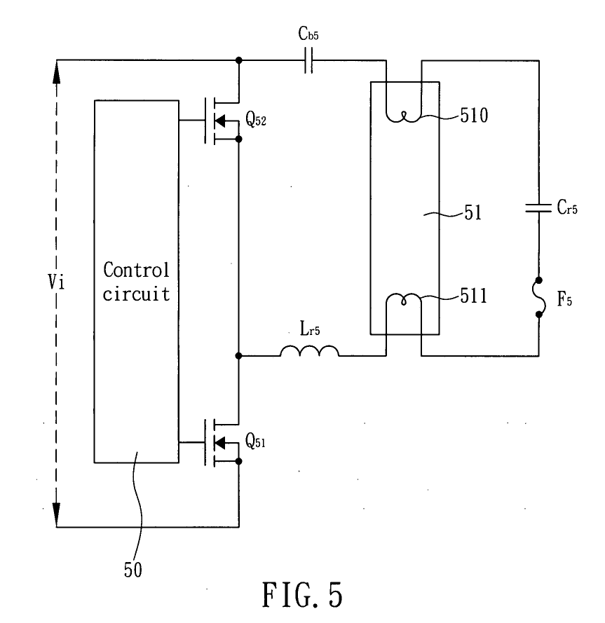

FIG. 5 shows a second embodiment of the present invention, wherein the resonant inductor Lᵣ₅ is series-connected between one end of the second filament 511 and the source of the second power switch Q₅₂, and the blocking capacitor C_{b5} is series-connected between one end of the first filament 510 and the drain of the second power switch Q₅₂. However, regardless of the variations in design of the fluorescent lamp circuit, the present invention is directed to a fluorescent lamp circuit wherein, referring to FIGS. 4 and 5, the resonant capacitor Cᵣ₅ is connected in series to the circuit breaking element F₅, and the series-connected resonant capacitor Cᵣ₅ and circuit breaking elements F₅ are connected in parallel to the two filaments 510 and 511, either to the right (as shown in FIGS. 4 and 5) or to the left (not shown) of the filaments 510 and 511. Based on the design concept of the present invention, a person skilled in the art may parallel-connect a circuit composed of the series-connected resonant capacitor Cᵣ₅ and circuit breaking elements F₅ to the two filaments 510 and 511 of any light tube 51, either on the left or right side of the filaments 510 and 511, so that the circuit breaking element F₅ forms an open circuit upon occurrence of an excessive resonant voltage and current at the resonant capacitor Cᵣ₅. All such equivalent circuits should fall within the scope of the present invention, which is defined only by the appended claims.

What is claimed is:

1. A fluorescent lamp circuit assured of recyclability and reusability, comprising:
a light tube having two ends provided with a first filament and a second filament respectively;
a power driving circuit comprising a control circuit, a first power switch, and a second power switch, the control circuit being configured to switch the first power switch and the second power switch respectively, the first power switch having a first end connected to a first end of the second power switch, the second power switch having a second end connected to a positive electrode of a power source and the first filament respectively, the first power switch having a second end connected to a negative electrode of the power source;
a resonant inductor connected between the second filament and a line connecting the first power switch and the second power switch;
a resonant capacitor; and
a circuit breaking element series-connected to the resonant capacitor, wherein the circuit breaking element and the resonant capacitor series-connected thereto are connected in parallel to the first filament and the second filament at the two ends of the light tube, the circuit breaking element having an allowable current value ensuring that all circuits and components in the fluorescent lamp circuit other than the circuit breaking element are prevented from burning;
wherein the resonant capacitor and the resonant inductor form a resonant circuit, and, according to switching control of the control circuit over the first power switch and the second power switch, an oscillation takes place in the resonant circuit to generate a resonant voltage and a resonant current at the resonant capacitor, the circuit breaking element forming an open circuit as soon as the resonant current exceeds the allowable current value of the circuit breaking element, thereby stopping operation of the resonant circuit.

2. The fluorescent lamp circuit of claim 1, further comprising a blocking capacitor, the blocking capacitor having an end connected to the line connecting the first power switch and the second power switch and an opposite end connected to the resonant inductor.

3. The fluorescent lamp circuit of claim 1, further comprising a blocking capacitor connected between the second power switch and the first filament.

4. The fluorescent lamp circuit of claim 2, wherein the first power switch has a gate connected to a control pin of the control circuit, a drain connected to a source of the second power switch, and a source connected to the negative electrode of the power source; and the second power switch has a gate connected to a control pin of the control circuit, and a drain connected to the positive electrode of the power source and the first filament, the control circuit switching the first power switch and the second power switch so as for the fluorescent lamp circuit to receive a stable input voltage from the power source.

5. The fluorescent lamp circuit of claim 3, wherein the first power switch has a gate connected to a control pin of the control circuit, a drain connected to a source of the second power switch, and a source connected to the negative electrode of the power source; and the second power switch has a gate connected to a control pin of the control circuit, and a drain connected to the positive electrode of the power source and the first filament, the control circuit switching the first power switch and the second power switch so as for the fluorescent lamp circuit to receive a stable input voltage from the power source.

6. The fluorescent lamp circuit of claim 4, wherein the circuit breaking element is a fuse.

7. The fluorescent lamp circuit of claim 5, wherein the circuit breaking element is a fuse.
